(19) United States
(12) Patent Application Publication
(10) Pub. No.: US 2022/0169420 A1
(43) Pub. Date: Jun. 2, 2022

(54) CONTAINER WITH CONVEX LENS

(71) Applicant: Canna Supply House LLC, Brooklyn, NY (US)

(72) Inventor: Daniel DiCapite, Brooklyn, NY (US)

(21) Appl. No.: 17/497,599

(22) Filed: Oct. 8, 2021

Related U.S. Application Data
(60) Provisional application No. 63/089,385, filed on Oct. 8, 2020.

(51) Int. Cl. B65D 23/12; G02B 7/02; B65D 25/54

(52) U.S. Cl. CPC B65D 23/12; G02B 7/02; B65D 2215/00; B65D 2203/12; B65D 25/54

(57) ABSTRACT

A container includes a convex lens. The container can be comprised of glass, plastic or a combination of glass and plastic. The lens can be formed with or fixed to a base of a container, embedded within the base of the container or molded within the base of the container. The properties of the lens depend on the height of the container, which determines the focal length for proper magnification. In an embodiment, the lens is substantially flat on one side while in another embodiment the lens can be curved on both sides. In an embodiment, the container can maintain a flat base with a natural curvature on the edges that enhance magnification or the visibility of an object arranged in the container.

### CROSS REFERENCE TO RELATED APPLICATION

This application claims the benefit of U.S. Provisional Patent Application No. 63/089,385 filed Oct. 8, 2020; the disclosures of which are incorporated herein by reference.

### BACKGROUND OF THE DISCLOSURE

### 1. Field of the Invention

The present disclosure relates generally to a container and more specifically to a container that incorporates a convex lens in a base thereof to aid in viewing an object within the container.

### 2. Background

Some sellers of products that are packaged in transparent jars desire a jar configuration that helps a user to view the products in the jars without opening the lid of the jar.

### SUMMARY OF THE DISCLOSURE

The present disclosure relates generally to a container that includes a convex lens. The container can be comprised of glass, plastic or a combination of glass and plastic. The lens can be formed with or fixed to a base of a container, embedded within the base of the container or molded within the base of the container. The properties of the lens depend on the height of the container, which determines the focal length for proper magnification. For example, a 2 inch (50.8 mm) tall container would use a 42 mm diameter double convex lens with a 68 mm focal length. In an embodiment, the lens can be substantially flat on one side while in another embodiment the lens can be curved on both sides. In an embodiment, the container can maintain a flat base with a natural curvature on the edges that enhance magnification or visibility of an object arranged in the container.

The disclosure generally relates to a jar with a magnifying convex lens integrated in the base of the jar. The lens has a focal length that is equal to or longer than the height of the jar, equal to or longer than the length of the sidewall of the jar, or equal to or longer than 80 percent of the length of the sidewall of the jar. This lens allows a user to look at a product located in the jar through the base of the jar and view a magnified image of the product or a portion of the product.

In use, when an object is placed in the container, the container is sealed with a covering (e.g., cap or lid) and rotated so that the bottom of the container can be viewed by an individual, the convex lens provides magnification to the contents inside. The cap or lid is a child-resistant-type cap or lid in some configurations.

### BRIEF DESCRIPTION OF THE DRAWINGS

FIG. 1A is a side view of a container that includes a one-sided convex lens as part of the base of the container according to an embodiment of the present disclosure.

FIG. 1B is an eye of an individual viewing the container of FIG. 1A.

FIG. 2A is a side view of a container that includes a convex lens embedded in a base of the container according to an embodiment of the present disclosure.

FIG. 2B is an eye of an individual viewing the container of FIG. 2A.

FIG. 3A is a side view of a container that includes a base in which a convex lens is formed according to an embodiment of the present disclosure.

FIG. 3B is an eye of an individual viewing the container of FIG. 3A.

FIG. 4A is a side view of a container that includes a base in which a convex lens is embedded therein according to an embodiment of the present disclosure.

FIG. 4B is an eye of an individual viewing the container of FIG. 4A.

FIG. 5 is a side view of a container that includes a base in which a convex lens is embedded therein according to an embodiment of the present disclosure.

FIG. 6 is a bottom plan view of the embodiment of the container depicted in FIG. 5.

### DETAILED DESCRIPTION OF THE DRAWINGS

With reference now to the drawings, embodiments of the container that includes a convex lens of the present disclosure will be described. In each of the configurations, a cap or lid is used to close the container. In some configurations, the lid or cap includes features that must be manipulated before the lid or cap is opened. These features make the lid or cap child resistant. The feature may be a cap or lid with two layers with the outer layer needing to be pushed down when turned to engage the inner layer or squeezed from the sides when turned to make the inner layer turned. Other type of child-resistant features also can be used.

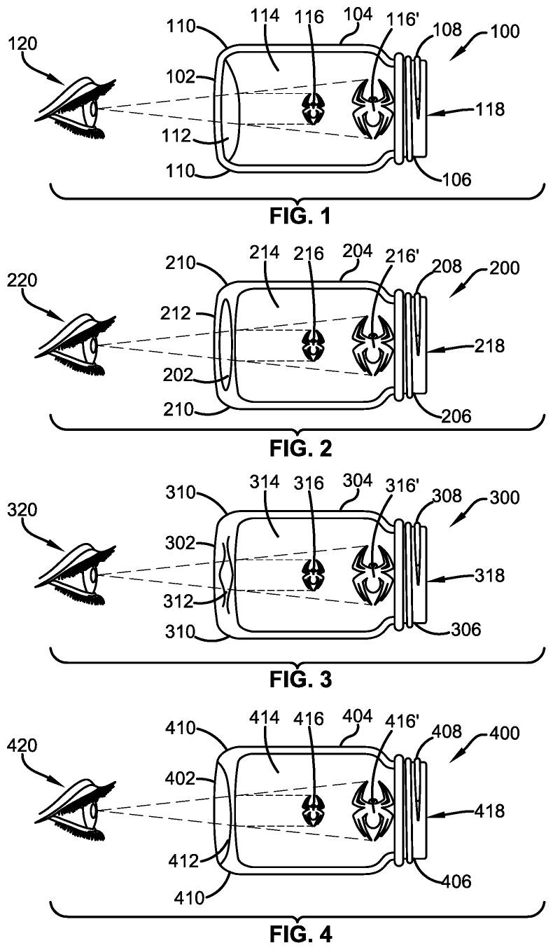

FIG. 1A illustrates an embodiment of a container 100 according to the present disclosure that includes a base 102 from which a sidewall 104 extends and a neck 106 that extends from the sidewall 104 and about which threading 108 that interacts with a covering (not shown) extend to aid in sealing the container 100. The base 102 includes a curved or rounded external outer periphery or edge 110.

A one-sided convex lens 112 (i.e., one side of the lens is flat and the other side of the lens is curved) extends from the base 102 within a cavity 114 of the container 100. The lens 112 can be molded within the base 102 of the container 100 with the lens 112 properties depending on the height of container 100, which determines the focal length for proper magnification of the object 116 arranged within the container 100.

As can be seen within the cavity 112 of the container 100 of FIG. 1A, an object 116 (e.g., a spider) is arranged through the opening 118 of the container 100. The object 116, as viewed through the base 102 by an eye 120 of an individual (see FIG. 1B), is magnified by the convex lens 110 such that details of the object 116 are enhanced as the object 116′ appears larger through the lens 110. The curved edge 110 of the base 102 aids in magnifying the object 116.

FIG. 2A illustrates another embodiment of a container 200 according to the present disclosure that includes a base 202 from which a sidewall 204 extends and a neck 206 that extends from the sidewall 204 and about which threading 208 that interacts with a covering (not shown) extend to aid in sealing the container 200. The base 202 includes a curved or rounded external outer periphery or edge 210.

A convex lens 212 is embedded within the base 202 and does not extend within a cavity 214 of the container 200. The properties of the lens 212 depend on the height of container 200, which determines the focal length for proper magnification of an object 216 arranged within the container 200.

As can be seen within the cavity 212 of the container 200 of FIG. 2A, the object 216 (e.g., a spider) is arranged through the opening 218 of the container 200. The object 216, as viewed through the base 202 by an eye 220 of an individual (see FIG. 2B), is magnified by the convex lens 210 such that details of the object 216 are enhanced as the object 216′ appears larger through the lens 210. The curved edge 210 of the base 202 aids in magnifying the object 216.

FIG. 3A illustrates yet another embodiment of a container 300 according to the present disclosure that includes a base 302 from which a sidewall 304 extends and a neck 306 that extends from the sidewall 304 and about which threading 308 that interacts with a covering (not shown) extends to aid in sealing the container 300. The base 302 includes a curved or rounded external outer periphery or edge 310.

A convex lens 312 is air embedded within the base 302 and does not extend within a cavity 314 of the container 300. The properties of the lens 312 depend on the height of container 300, which determines the focal length for proper magnification of an object 316 arranged within the container 300.

As can be seen within the cavity 312 of the container 300 of FIG. 3A, the object 316 (e.g., a spider) is arranged through the opening 318 of the container 300. The object 316, as viewed through the base 302 by an eye 320 of an individual (see FIG. 3B), is magnified by the lens 310 such that details of the object 316 are enhanced as the object 316′ appears larger through the lens 310. The curved edge 310 of the base 302 aids in magnifying the object 316.

FIG. 4A illustrates an embodiment of a container 400 according to the present disclosure that includes a base 402 from which a sidewall 404 extends and a neck 406 that extends from the sidewall 404 and about which threading 408 that interacts with a covering (not shown) extend to aid in sealing the container 400. The base 402 includes a curved or rounded external outer periphery or edge 410.

A one-sided convex lens 412 (i.e., one side of the lens is flat and the other side of the lens is curved) is embedded within the base 402 of the container 400. The lens 412 can be molded within the base 402 of the container 400 with the lens 412 properties depending on the height of container 400, which determines the focal length for proper magnification of the object 416 arranged within the container 400.

As can be seen within the cavity 412 of the container 400 of FIG. 4A, an object 416 (e.g., a spider) is arranged through the opening 418 of the container 400. The object 416, as viewed through the base 402 by an eye 420 of an individual (see FIG. 4B), is magnified by the convex lens 410 such that details of the object 416 are enhanced as the object 416′ appears larger through the lens 410. The curved edge 410 of the base 402 aids in magnifying the object 416.

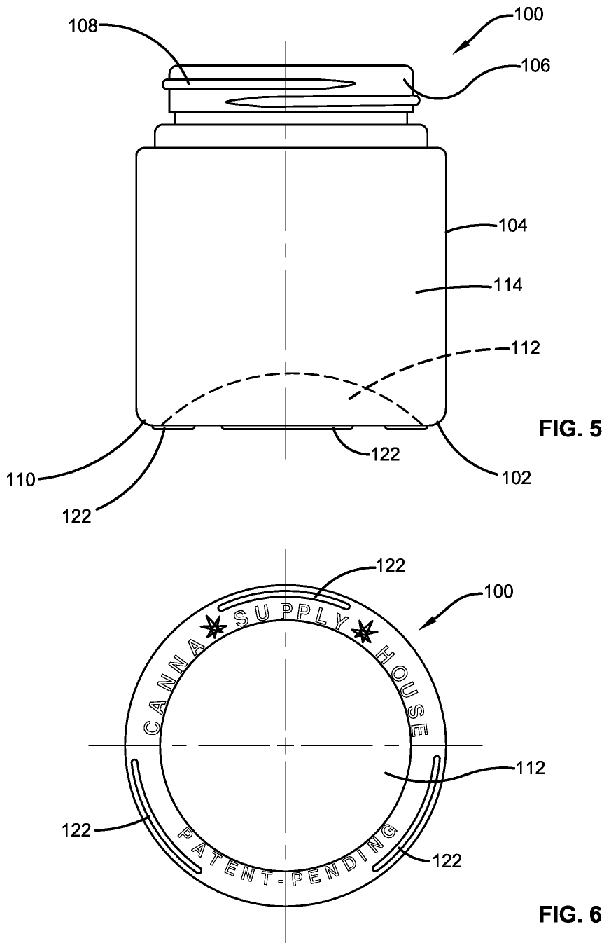

FIGS. 5 and 6 illustrate an exemplary configuration of container 100 that includes a base 102 from which a sidewall 104 extends and a neck 106 that extends from the sidewall 104 and about which threading 108 that interacts with a covering (not shown) extend to aid in sealing the container 100. The base 102 includes a curved or rounded external outer periphery or edge 110. The dimensions shown in FIG. 5 are in millimeters. When the outer surface of sidewall 104 is covered with a label, the outer periphery edge 110 provides light for viewing the contents of container 100 through lens 112.

A one-sided convex lens 112 (i.e., the outer side of the lens is flat and the inner side of the lens is curved) extends from the base 102 within a cavity 114 of the container 100. The lens 112 can be molded within the base 102 of the container 100 with the lens 112 properties depending on the height of container 100, which determines the focal length for proper magnification of the object or object or a portion of the object arranged within the container 100. In this configuration, the focal length is equal to or longer than the height of container 100 and is thus equal to or longer than 67 mm, equal to or longer than the height of sidewall 104 and is thus equal to or longer than 51.5 mm, or equal to or longer than 80 percent of the height of sidewall 104 and is thus equal to or longer than 41.2 mm.

The configuration of FIGS. 5 and 6 includes feet 122 that prevent the flat surface of lens 112 from contacting a surface when container 100 is standing on that surface.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A container, comprising:
a jar body having a base that includes a convex lens that is one of molded within the base, molded to the base and formed within the base; the convex lens having a flat outer surface and a curved inner surface.

2. A container, comprising:
a body having a base and a sidewall; the body having a height, sidewall having a height that is less than the height of the body;
the base including a convex lens with a flat outer surface and a curved inner surface; the convex lens adapted to magnify at least a portion of an item located in the container when viewed through the lens from an exterior of the container; and
the lens having a focal length longer than the height of the body.

3. The container of claim 2, wherein the sidewall is cylindrical and perpendicular to the flat outer surface of the lens.

4. The container of claim 2, wherein the body includes a curved external outer edge between the flat outer surface of the lens and the sidewall.

5. The container of claim 2, wherein the body includes an externally-projecting thread.

6. The container of claim 5, further comprising a lid removably engaging the thread of the body.

7. A container, comprising:
a body having a base and a sidewall; the body having a height, sidewall having a height that is less than the height of the body;
the base including a convex lens with a flat outer surface and a curved inner surface; the convex lens adapted to magnify at least a portion of an item located in the container when viewed through the lens from an exterior of the container; and
the lens having a focal length that is at least eighty percent of the height of the sidewall.

8. The container of claim 7, wherein the sidewall is cylindrical and perpendicular to the flat outer surface of the lens.

9. The container of claim 7, wherein the body includes a curved external outer edge between the flat outer surface of the lens and the sidewall.

10. The container of claim 7, wherein the body includes a neck having an externally-projecting thread.

11. The container of claim 10, further comprising a lid removably engaging the thread of the body.

12. The container of claim 11, wherein the lid includes a child-resistant feature.

13. The container of claim 7, wherein the focal length of the lens is at least the height of the sidewall.

14. The container of claim 13, wherein the focal length of the lens is at least the height of the body.

15. The container of claim 7, wherein the base and sidewall are glass.
